(19) United States
(12) Patent Application Publication
(10) Pub. No.: US 2013/0207903 A1
(43) Pub. Date: Aug. 15, 2013

(54) TOUCH PANEL

(71) Applicants: YU-CHOU YEH, Hsinchu City (TW); Wen-Chih Lo, Hsinchu City (TW)

(72) Inventors: YU-CHOU YEH, Hsinchu City (TW); Wen-Chih Lo, Hsinchu City (TW)

(73) Assignee: J Touch Corporation, Taoyuan Hsien (TW)

(21) Appl. No.: 13/372,599

(22) Filed: Feb. 14, 2012

(51) Int. Cl. G06F 3/041

(52) U.S. Cl. 345/173

(57) ABSTRACT

A touch panel, adapted for a touch control apparatus with a display unit, is disclosed, which comprises: a protection plate, having a covering area and a transparent area formed on a surface thereof; a touch sensitive layer, arranged between the protection plate and the display unit at a position corresponding to the transparent area; a conductive circuit, arranged between the protection plate and the display unit at a position corresponding to the transparent area while being electrically connected to the touch sensitive layer. In addition to the expected touch control functions, the touch panel of the invention can enable more icons to be displayed on the display unit.

### FIELD OF THE INVENTION

The present invention relates to a touch panel, and more particularly, to a touch panel with narrow frame.

### BACKGROUND OF THE INVENTION

As shown in FIG. 1, FIG. 2, and FIG. 3, a conventional touch control apparatus 1 is composed of a touch panel 11 and a display unit 13, in which the touch panel 11 is generally protected under a layer of protection plate 111 or cover glass (CG). Moreover, the frame 1111 of the protection plate 111 that is formed on the perimeter of the protection plate 111 is usually opaque for aesthetic reasons, since the conductive circuit 115 that is electrically connected to the touch sensitive layer 113 is generally made of non-transparent metal lines and is required to be hide behind the opaque frame 1111.

Recently, touch control apparatus with narrow frame is becoming more and more popular, and therefore, the conventional touch panel 11 with conventional frame is no longer appropriate and required to be improved for meeting the modern demand of narrow frame. In addition, due to the existence of the conductive circuit 115, the number of icons capable of being displayed simultaneously on the touch control apparatus using conventional touch panel 11 is limited and difficult to increase. As shown in FIG. 3, there are only six icons 16 capable of being displayed on the transparent area 1110 or the display area of the touch control apparatus 1. Such limitation is unfavorable for developing a new touch control product that is smaller, thinner and lighter.

Therefore, it is in need of an improved touch panel adapted for touch control apparatuses that is designed to overcome the aforesaid shortcomings.

### SUMMARY OF THE INVENTION

The object of the present invention is to provide a touch panel adapted for a touch control apparatus, capable of enabling the touch control apparatus to be designed with narrower frame while enabling more icons to be displayed simultaneously thereon.

To achieve the above object, the present invention provides a touch panel, adapted for a touch control apparatus with a display unit, comprising: a protection plate, having a covering area and a transparent area formed on a surface thereof; a touch sensitive layer, arranged between the protection plate and the display unit at a position corresponding to the transparent area; a conductive circuit, arranged between the protection plate and the display unit at a position corresponding to the transparent area while being electrically connected to the touch sensitive layer.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is an exploded view of a conventional touch control apparatus.

FIG. 2 is a cross sectional view of FIG. 1.

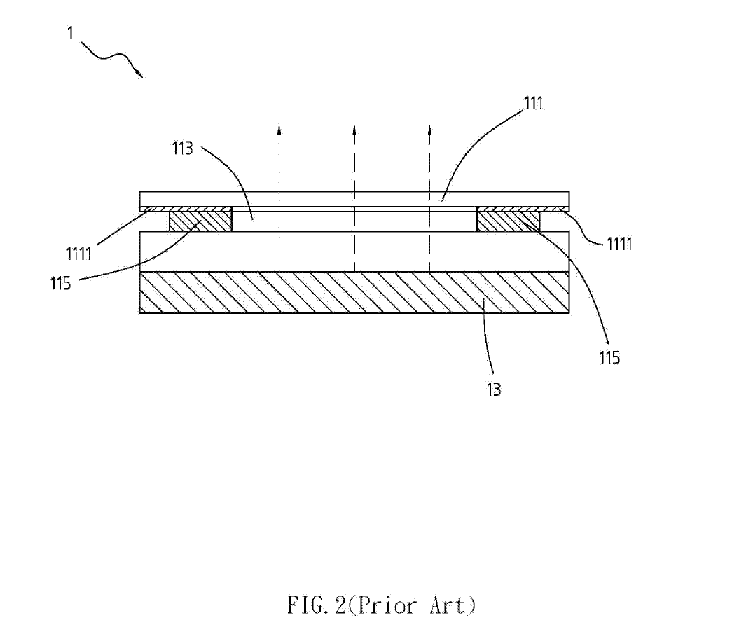

FIG. 3 is a schematic diagram showing an exemplary displaying capability of the conventional touch control apparatus of FIG. 1 that it can enable six icons to be displayed simultaneously on its display unit.

FIG. 4 is an exploded diagram showing a touch control apparatus according to a first embodiment of the invention.

FIG. 5 is a cross sectional view of FIG. 4.

FIG. 6 is a cross sectional diagram showing a touch control apparatus according to a second embodiment of the invention.

FIG. 7 is a schematic diagram showing an exemplary displaying capability of a touch control apparatus using a touch panel of the invention that it can enable twelve icons to be displayed simultaneously on its display unit.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

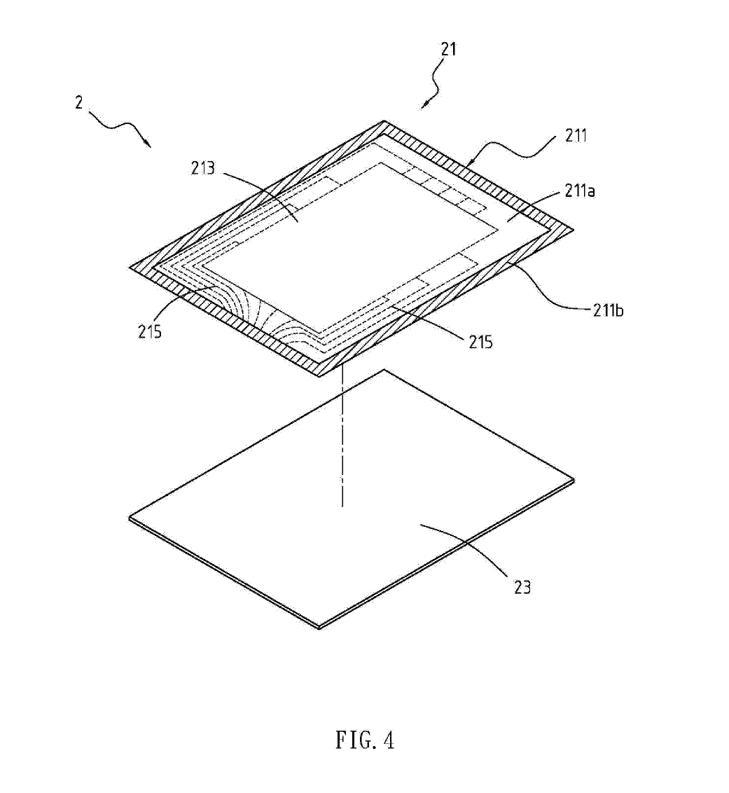

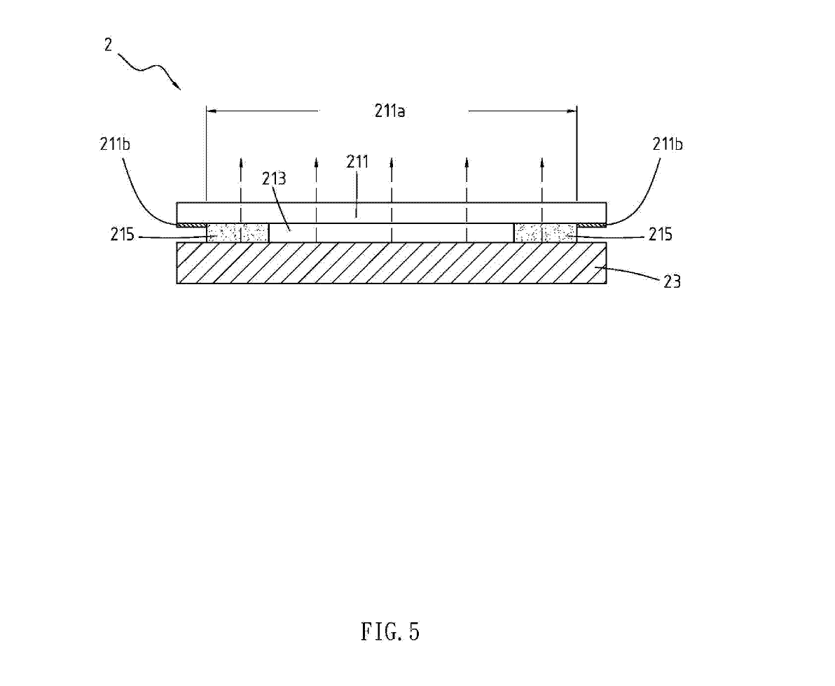

Please refer to FIG. 4 and FIG. 5, which are an exploded diagram showing a touch control apparatus according to a first embodiment of the invention, and a cross sectional view of FIG. 4. As shown in FIG. 4 and FIG. 5, a touch control apparatus 2 is composed of: a touch panel 21 of the invention and a display unit 23, in which the touch panel 21 is attached on a top surface of the display unit 23 and the display unit 23 can be a conventional flat panel display, such as a liquid crystal display (LCD), an organic light emitting diode (OLED), a plasma panel display (PDP) or an e-paper, and so on. In this embodiment, the touch panel 21 is configured with a protection plate 211, a touch sensitive layer 213 and a conductive circuit 215, that will be described hereinafter.

One specific function of the protection plate 211 is to protect the touch control apparatus 2, and thus it is usually a transparent thin plate made of a material selected from the group consisting of: glass, polycarbonate (PC). polyethylene terephthalate (PET), polymethylmethacrylate (PMMA), and cyclic olefin copolymer (COC). As shown in FIG. 4 and FIG. 5, there are a transparent area 211a and a covering area 211b formed on a surface of the protection plate 211. Wherein, the transparent area 211a is the area capable of allowing beams emitting from the display unit 23 to travel passing therethrough, as indicated by the dotted lines in FIG. 5, so as to show a picture of operation icons. Moreover, the covering area 211b is a coating on the perimeter of the lower surface of the protection plate 211 and is formed from the use of an opaque material selected from the group consisting of: an ink, a color photoresist, an organic material, and an inorganic material; and moreover, it is capable of being formed by a conventional means, such as printing, coating, or metal evaporation deposition.

The touch sensitive layer 213, which can be a capacitive touch sensor or a resistive touch sensor, is arranged between the protection plate 211 and the display unit 23 at a position corresponding to the transparent area 211a. It is noted that the touch sensitive layer 213 can be any conventional touch sensor and thus is not described further herein. Nevertheless, operationally, the touch sensitive layer 213 can be formed directly on the lower surface of the protection plate 211 by sputtering or etching.

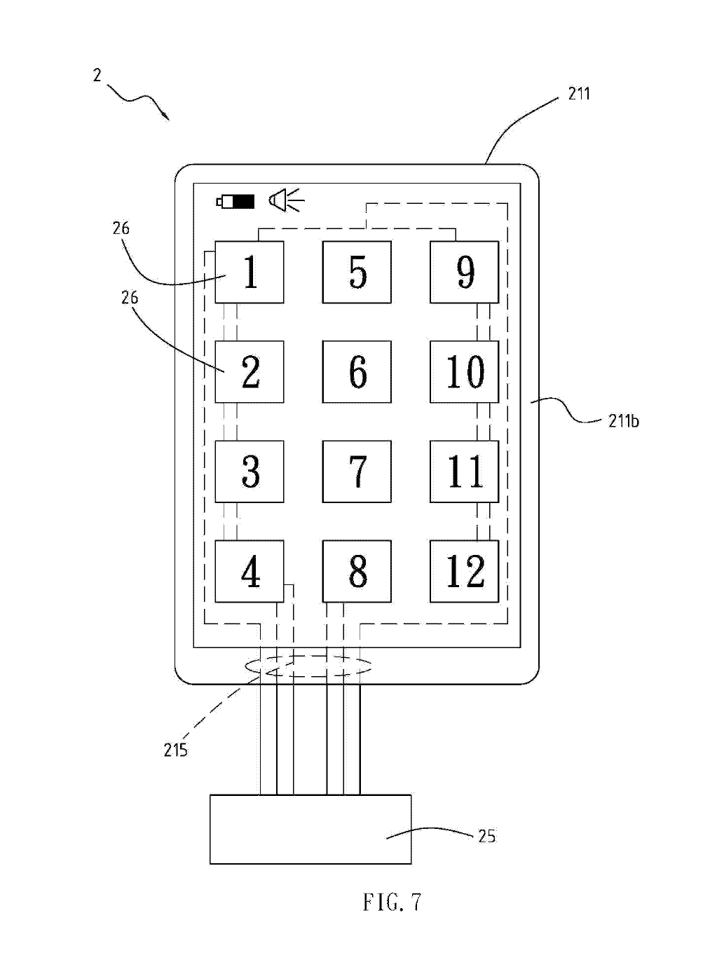

The conductive circuit 215 is also arranged between the protection plate 211 and the display unit 23 at a position corresponding to the transparent area 211a; and the conductive circuit 215 of the invention is made of a transparent conductive material selected from the group consisting of: graphene, indium tin oxide (ITO), indium zinc oxide (IZO), and aluminum zinc oxide (AZO). Moreover, the conductive circuit 215 is also formed on the lower surface of the protection plate 211 while having one end thereof to connect electrically to the touch sensitive layer 213 and another end thereof to connect electrically to a controller 25, as shown in FIG. 7. Since the conductive circuit 215 is transparent, light emitting from the display unit 23 is able to travel passing therethrough, as indicated by the dotted lines in FIG. 5.

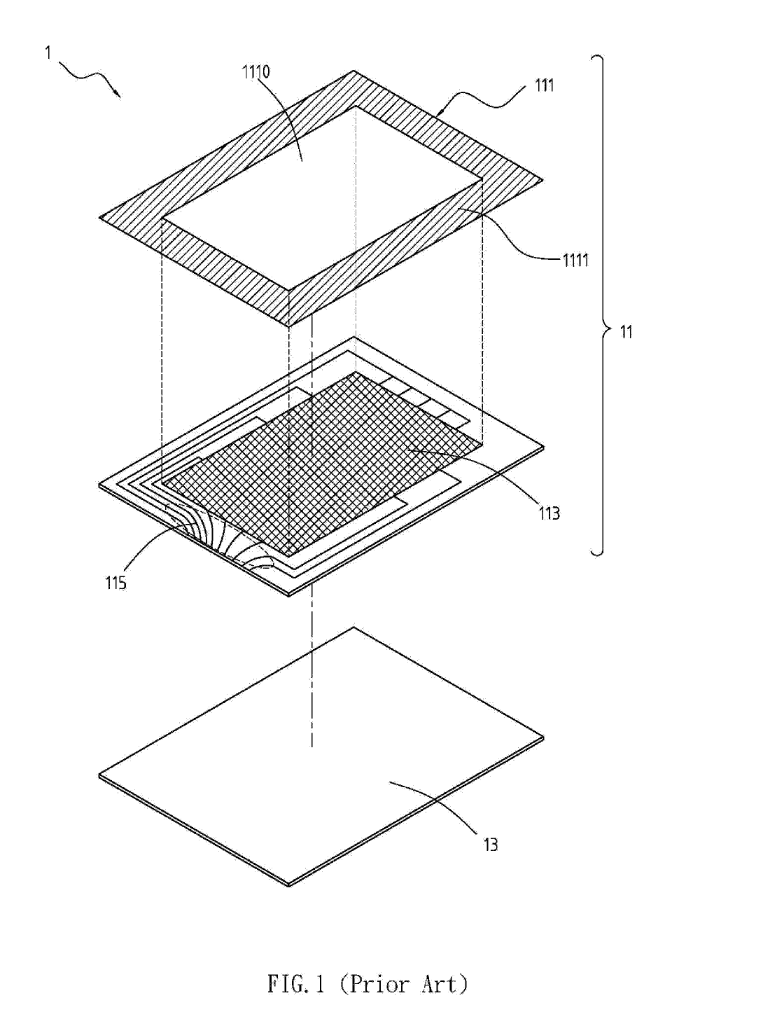

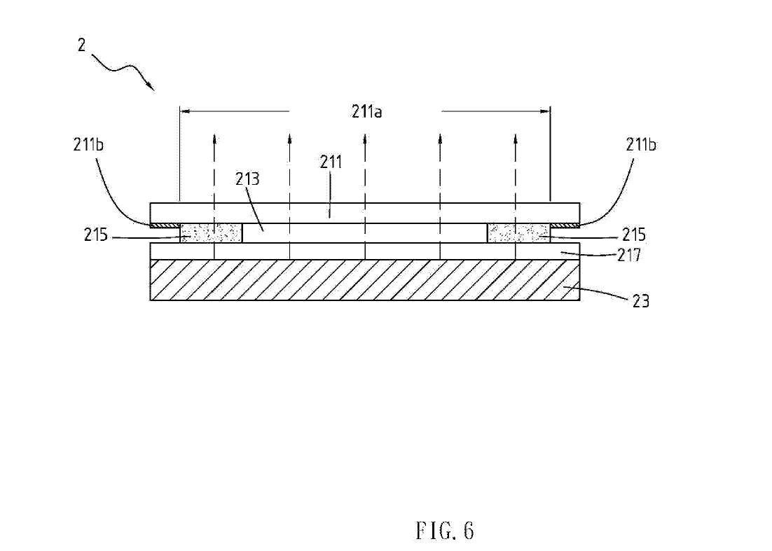

Please refer to FIG. 6, which is a cross sectional diagram showing a touch control apparatus according to a second embodiment of the invention. The difference between this second embodiment and the first embodiment is that: there is an additional transparent substrate 217 being arranged under the touch sensitive layer 213 and the conductive circuit 215 at a position above the display unit 23, while allowing other components to remain the same. For clarification purpose, the difference between the device shown in this second embodiment and the conventional device shown in FIG. 1 is that: the conductive circuit 215 in this second embodiment is made of a transparent conductive material. Operationally, a conventional glass-to-glass (G/G) touch panel technology is adopted for gluing and bonding two transparent thin plates, i.e. the transparent substrate having the touch sensitive layer 213 and the conductive circuit 215 formed thereon, and the protection plate 211, by the use of an optically clear adhesive, so as to construct the touch panel 21.

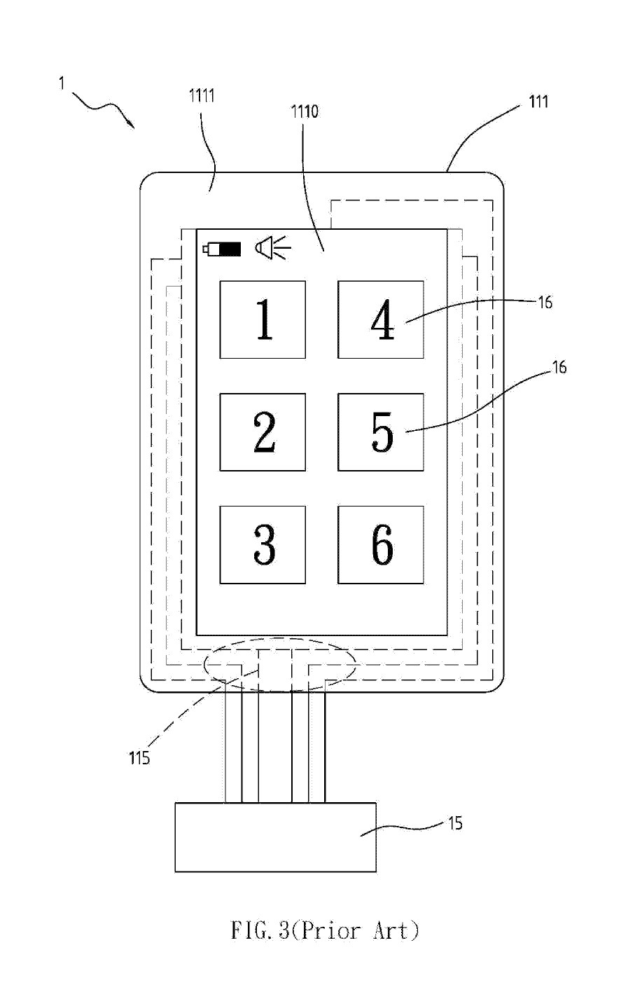

Please refer to FIG. 7, which is a schematic diagram showing an exemplary displaying capability of a touch control apparatus using a touch panel of the invention that it can enable twelve icons 26 to be displayed simultaneously on its display unit. Comparing the example shown in FIG. 7 with that shown in FIG. 3, it is noted that the touch control panel which adopts the touch panel 21 of the invention is able to display more icons. In this case, there are twelve icons comparing with six. To sum up, by the use of a transparent conductive material to form the conductive circuit 215, there can be more icons and more information as well to be displayed simultaneously on the display unit 23. Not to mention that the protection plate 211 can be formed with narrower covering area 211b for aesthetic reasons. In addition, since there are more icons to be displayed simultaneously on the display unit 23, the number of screen switch that is performed on the touch control apparatus 2 can be reduced and thus the energy consumption is reduced.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. A touch panel, adapted for a touch control apparatus with a display unit, comprising:
a protection plate, having a covering area and a transparent area formed on a surface thereof;
a touch sensitive layer, arranged between the protection plate and the display unit at a position corresponding to the transparent area;
a conductive circuit, arranged between the protection plate and the display unit at a position corresponding to the transparent area while being electrically connected to the touch sensitive layer.

2. The touch panel of claim 1, further comprising:
a transparent substrate, disposed under the touch sensitive layer and the conductive circuit at a position above the display unit.

3. The touch panel of claim 1, wherein the conductive circuit is made of a transparent conductive material selected from the group consisting of: graphene, indium tin oxide (ITO), indium zinc oxide (IZO), and aluminum zinc oxide (AZO).

4. The touch panel of claim 1, wherein the protection plate is a transparent thin plate made of a material selected from the group consisting of: glass, polycarbonate (PC), polyethylene terephthalate (PET), polymethylmethacrylate (PMMA), and cyclic olefin copolymer (COC).

5. The touch panel of claim 1, wherein the covering area is a coating formed from the use of an opaque material selected from the group consisting of: an ink, a color photoresist, an organic material, and an inorganic material.

6. The touch panel of claim 1, wherein the touch sensitive layer is a device selected from the group consisting of: a capacitive touch sensor, and a resistive touch sensor,

7. The touch panel of claim 1, wherein the display unit is a device selected from the group consisting of: a liquid crystal display (LCD), an organic light emitting diode (OLED), a plasma display panel (PDP), and an e-paper.
